(19) United States
(12) Patent Application Publication
(10) Pub. No.: US 2019/0271591 A1
(43) Pub. Date: Sep. 5, 2019

(54) LIGHT SOURCE MEASUREMENT MONITORING METHOD AND SYSTEM OF SPECTROMETER

(71) Applicant: InnoSpectra Corporation, Hsinchu County (TW)

(72) Inventors: Cheng-Hsiung Chen, Hsinchu County (TW); Yung-Yu Huang, Hsinchu County (TW); Ming-Hui Lin, Hsinchu County (TW); He-Yi Hsieh, Hsinchu County (TW); Hsi-Pin Li, Hsinchu County (TW)

(73) Assignee: InnoSpectra Corporation, Hsinchu County (TW)

(21) Appl. No.: 16/286,615

(22) Filed: Feb. 27, 2019

(30) Foreign Application Priority Data
Mar. 2, 2018 (CN) 201810174992.8

(51) Int. Cl. G01J 3/02; G01J 3/28; G01J 3/10; G01N 21/25

(52) U.S. Cl. CPC G01J 3/0275; G01J 3/28; G01N 21/255; G01J 3/027; G01J 3/10

(57) ABSTRACT

A light source measurement monitoring method and system of a spectrometer are provided. The method includes: driving a test light source by a driving parameter; obtaining sensing data related to the test light source through a sensor; comparing the sensing data with a predetermined range to generate a comparison result; starting performing a spectrum measurement to a test object when the sensing data falls within the predetermined range; and sending a warning signal when the sensing data is out of the predetermined range.

### CROSS-REFERENCE TO RELATED APPLICATION

This application claims the priority benefit of China application serial no. 201810174992.8, filed on Mar. 2, 2018. The entirety of the above-mentioned patent application is hereby incorporated by reference herein and made a part of this specification.

### BACKGROUND OF THE INVENTION

### Field of the Invention

The invention relates to an optical measurement technology, and particularly relates to a light source measurement monitoring method and system of a spectrometer.

### Description of Related Art

A spectrometer used as a widely used instrument for material analysis is adapted to receive a light beam coming from a test object to produce a corresponding spectrogram. By analysing a characteristic (spectrogram) of light absorbed or reflected by the test object, a feature of the test object is learned, for example, after the test object is irradiated by a reference light source, the light is changed into a test light, and material components or related features of the test object may be learned by analysing the spectrogram of the test light, and composition and energy distribution of each color band are also learned.

However, since lighting stability of a test light source is influenced by many factors, a measurement result is probably abnormal, and an actual characteristic of the test light source cannot be obtained, for example, factors such as that spectrum measurement is started from a cold start of the light source before the light source reach a stable state, a light source intensity is varied along with time change, and a driving parameter (for example, a current or a voltage) of the light source is changed such that a light intensity is changed or the light source intensity is gradually decreased along with increase of a usage time.

Therefore, during the process that the spectrometer measures the test light source, to determine whether the measurement result is reliable is an important issue of the current optical measurement technology.

The information disclosed in this “BACKGROUND OF THE INVENTION” is only for enhancement of understanding of the background of the described technology and therefore it may contain information that does not form the prior art that is already known to a person of ordinary skill in the art. Further, the information disclosed in the “BACKGROUND OF THE INVENTION” does not mean that one or more problems to be resolved by one or more embodiments of the invention was acknowledged by a person of ordinary skill in the art.

### SUMMARY OF THE INVENTION

The invention is directed to a light source measurement monitoring method and system of a spectrometer, which are adapted to help the spectrometer to obtain a reliable spectrum measurement result, and determine a state of a test light source, so as to provide an optimal time point for the spectrometer to start scanning.

Other objects and advantages of the invention can be further illustrated by the technical features broadly embodied and described as follows.

In order to achieve one or a portion of or all of the objects or other objects, an embodiment of the invention provides a light source measurement monitoring method of a spectrometer including: driving a test light source by a driving parameter; obtaining sensing data related to the test light source through a sensor; comparing the sensing data with a predetermined range to generate a comparison result; starting performing a spectrum measurement to a test object when the sensing data falls within the predetermined range; and sending a warning signal when the sensing data is out of the predetermined range.

An embodiment of the invention provides a light source measurement monitoring system of a spectrometer, which is adapted to monitor a spectrometer used for measuring a test object, and includes a sensor, a memory, a warning device and a processor. The sensor is disposed beside a test light source, and is configured to sense the test light source driven by a driving parameter and obtain sensing data. The memory stores the driving parameter and a predetermined range. The warning device is used for sending a warning signal. The processor is coupled to the memory, the warning device and the sensor, and the processor receives the sensing data from the sensor and compares the sensing data with a predetermined range to generate a comparison result, where when the sensing data falls within the predetermined range, the spectrometer starts performing a spectrum measurement to the test object, and when the sensing data is out of the predetermined range, the processor controls the warning device to send the warning signal.

Based on the above description, the embodiments of the invention have one or following advantages or effect. In the light source measurement monitoring method and system of the spectrometer of the invention, the sensor is adapted to sense the test light source to generate the sensing data, and the sensing data and the predetermined range are compared to determine whether the spectrometer is adapted to perform the spectrum measurement, and when the sensing data falls within the predetermined range, the spectrometer starts performing the spectrum measurement to the test object, and when the sensing data is out of the predetermined range, the warning device sends the warning signal to remind that the test light source is probably in an aging state or is abnormal, or remind that the spectrum measurement result of this time is probably not consistent. Therefore, a user may learn when to start performing the spectrum measurement, and confirm whether the measurement result of the spectrometer is obtained under a stable state of the test light source, so as to improve reliability of the measurement result of the spectrometer.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block schematic diagram of a light source measurement monitoring system of a spectrometer according to an embodiment of the invention.

FIG. 2 is a flowchart illustrating a light source measurement monitoring method of a spectrometer according to an embodiment of the invention.

FIG. 3 is a schematic diagram of sensing data varied along with time according to an embodiment of the invention.

FIG. 4 is a schematic diagram of sensing data varied along with time according to another embodiment of the invention.

### DESCRIPTION OF EMBODIMENTS

The present invention will now be described more fully with reference to the accompanying drawings, in which exemplary embodiments of the invention are shown. The terms used herein such as “above”, “below”, “front”, “back”, “left” and “right” are for the purpose of describing directions in the figures only and are not intended to be limiting of the invention.

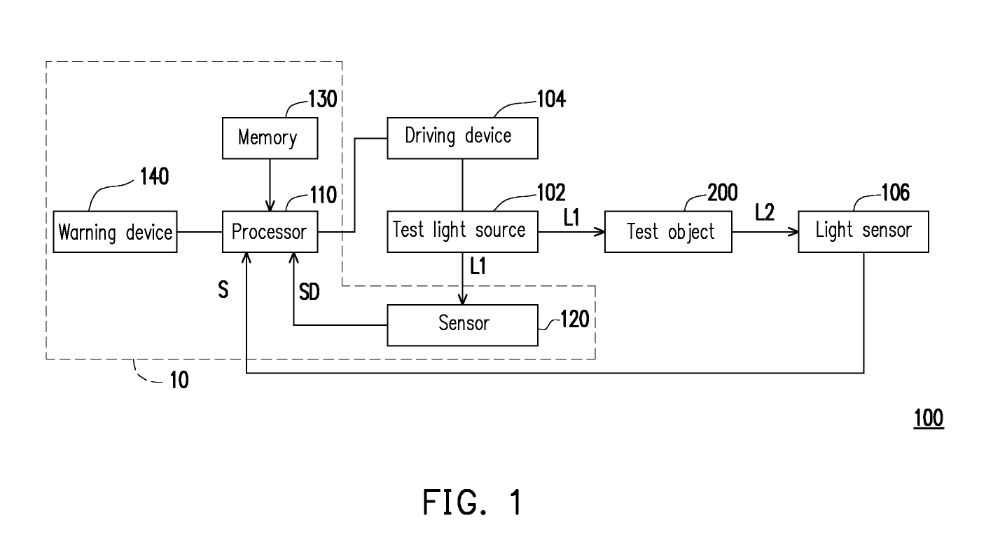

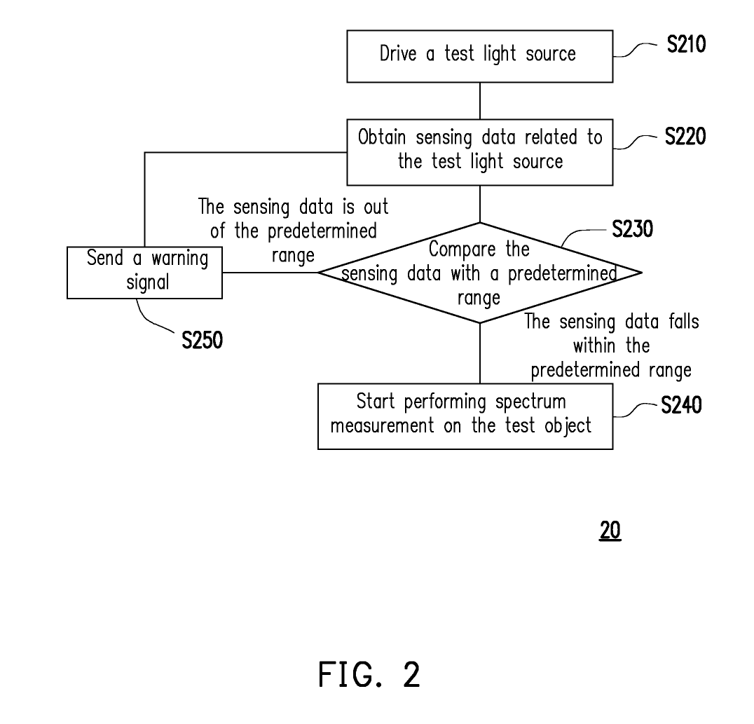

FIG. 1 is a block schematic diagram of a light source measurement monitoring system of a spectrometer according to an embodiment of the invention. FIG. 2 is a flowchart illustrating a light source measurement monitoring method of a spectrometer according to an embodiment of the invention. Referring to FIG. 1 and FIG. 2, in the present embodiment, the light source measurement monitoring system 10 is adapted to execute the light source measurement monitoring method 20 of FIG. 2, and detailed steps of the light source measurement monitoring method 20 are described below with reference of various components of FIG. 1.

The light source measurement monitoring system 10 is used for monitoring a light source of a spectrometer 100 measuring a test object 200. The light source measurement monitoring system 10 may be a system disposed in the spectrometer 100, or a system independent to the spectrometer 100. In the embodiment, the light source measurement monitoring system 10 is disposed in the spectrometer 100, though the invention is not limited thereto. In the embodiment of FIG. 1, the spectrometer 100 includes the light source measurement monitoring system 10, a test light source 102, a driving device 104 and a light sensor 106. The light source measurement monitoring system 10 includes a processor 110, a sensor 120, a memory 130 and a warning device 140, where the processor 110 is coupled to the sensor 120, the memory 130, the warning device 140 and the driving device 104. The driving device 104 is coupled to the test light source 102, and is used for driving the test light source 102 according to a driving parameter, where the driving parameter is, for example, a voltage value and/or a current value, etc. The light sensor 106 is coupled to the processor 110 of the light source measurement monitoring system 10.

In the embodiment of FIG. 1, the test light source 102 of the spectrometer 100 is disposed beside the test object 200 (for example, a test sample), and the sensor 120 is disposed beside the test light source 102, the driving device 104 drives the test light source 102 to emit light L1 according to the driving parameter, and the light L1 irradiates the test object 200 and a test light L2 (for example, a penetration light, a reflected light or a excited light) is correspondingly outputted. The light sensor 106 of the spectrometer 100 receives the test light L2 coming from the test object 200 to generate a sensing signal S corresponding to the test light L2, and the sensing signal S is transmitted to the processor 110 to generate spectrum data corresponding to the test object 200. In the embodiment, the test light source 102, for example, has a wavelength range between 900 nm and 1700 nm. In other embodiment, if the light source measurement monitoring system 10 is the system independent to the spectrometer 100, the spectrometer 100 may further include a control circuit (not shown), and the control circuit may be respectively coupled to the light sensor 106 and the processor 110 of the light source measurement monitoring system 10, while the light sensor 106 is not coupled to the processor 110 of the light source measurement monitoring system 10, and the control circuit receives the sensing signal from the light sensor 106 to perform analysis.

Referring to FIG. 1 and FIG. 2, in step S210, the driving device 104 drives the test light source 102 to irradiate the test object 200 and the test light L2 is outputted correspondingly. In step S220, the sensor 120 senses the light L1 emitted by the test light source 102 or/and sense the test light source 102 to generate the sensing data SD related to the test light source 102.

In step S230, the processor 110 obtains the sensing data SD related to the test light source 102 that is sensed by the sensor 120 and receives a predetermined range from the memory 130, and compares the sensing data SD with the predetermined range to generate a comparison result. The predetermined range is, for example, a fixed threshold, a fixed value range, or a variation rate of the sensing data SD within a unit time, and the predetermined range may also be a threshold or value range varied along with an actual usage requirement or setting.

When the comparison result of the processor 110 indicates that the sensing data SD falls within the predetermined range, a step S240 is executed. In the step S240, the spectrometer 100 starts performing spectrum measurement on the test object 200. In the embodiment, the processor 110 is coupled to the light sensor 106 of the spectrometer 100, and the processor 110 may automatically send a measurement start signal to the light sensor 106 to notify the light sensor 106 to start measuring the test object 200. In another embodiment, the processor 110 may not be coupled to the light sensor 106 of the spectrometer 100, and only controls the warning device 140 to send a measurement notice, and the user manually operates the spectrometer 100 to perform the spectrum measurement.

When the comparison result of the processor 110 indicates that the sensing data SD is out of the predetermined range, a step S250 is executed. In the step S250, the processor 110 controls the warning device 140 to send a warning signal to notify the user that the test light source 102 is in an abnormal state. After the step S250, the step S220 may be re-executed, and the processor 110 controls the sensor 120 to continually sense the light L1 emitted by the test light source 102 to generate the sensing data SD related to the test light source 102, and determines whether the sensing data SD is within the predetermined range. In the embodiment, the processor 110 is coupled to the driving device 104 of the test light source 102 and stores the driving parameter to the memory 130, and when the sensing data SD exceeds the predetermined range, the processor 110 controls the driving device 104 to maintain the driving parameter originally input to the memory 130. However, it is not limited that the processor 110 must be coupled to the driving device 104 of the test light source 102, and in other embodiments, the driving parameter of the driving device 104 may be recorded to the memory 130 through an input interface or device.

To be specific, the processor 110 is, for example, hardware having computation capability (for example, a chipset, a processor, etc.). In the embodiment, the processor 110 is, for example, a Central Processing Unit (CPU), or other programmable microprocessor, a Digital Signal Processor (DSP), a programmable controller, an Application Specific Integrated Circuit (ASIC), a programmable Logic Device (PLD), or other similar devices, though the invention is not limited thereto.

The sensor 120 of the light source measurement monitoring system 10 is, for example, a light sensor or a temperature sensor, or other types of sensor. When the sensor 120 is a light sensor, the sensor 120 receives the light L1 coming from the test light source 102, and in this case, the sensing data SD is, for example, a brightness; when the sensor 120 is a temperature sensor, the sensor 120 senses the temperature of the test light source 102, and the sensing data is, for example, a temperature, and a measurement type of the sensor 120 on the test light source 102 is not limited by the invention. The light sensor 106 of the spectrometer 100 is, for example, a photo diode or a device integrated by a photosensitive element and a circuit having a photoelectric signal conversion function, etc. The light sensor 106 is used for sensing the test light L2 coming from the test object 200, and transmits the sensing signal S corresponding to the test light L2 to the processor 110, so as to generate spectrum data corresponding to the test object 200.

The memory 130 is, for example, any type of a fixed or mobile Random Access Memory (RAM), a Read-Only Memory (ROM), a flash memory, a hard disk or a similar device or a combination of the above devices, though the invention is not limited thereto. The memory 130 is used for storing the predetermined range and storing other data, program codes, images, etc., probably used in operation of the light source measurement monitoring system 10. Namely, the processor 110 is configured to execute a plurality of instructions stored in the memory 130 to control the light source measurement monitoring system 10, and implement the light source measurement monitoring method 20.

The warning device 140 is, for example, a sound warning device, for example, a buzzer, a loudspeaker or a voice device, or a warning lamp, for example, a Light Emitting Diode (LED), a lamp or other proper light source, or a screen display device (for example, a pattern or a text is displayed on the screen to warn the user), or other devices having the warning function or a combination of the above devices, which is not limited by the invention.

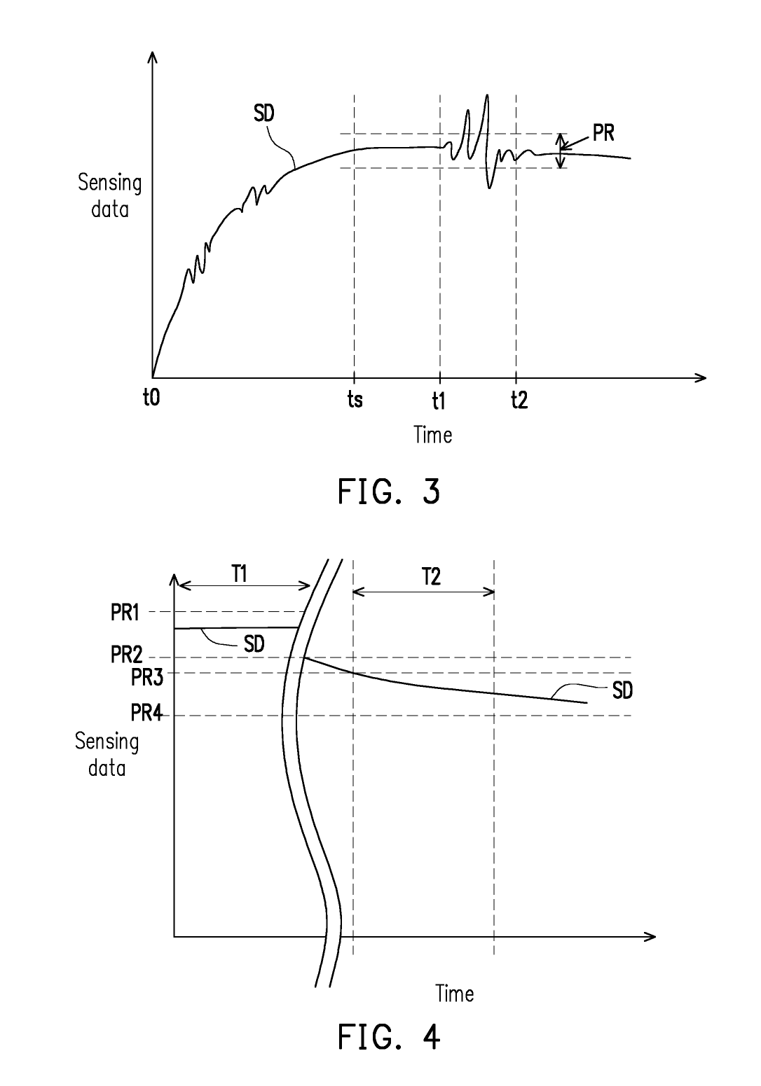

FIG. 3 is a schematic diagram of the sensing data varied along with time according to an embodiment of the invention. Referring to FIG. 1 and FIG. 3, in an embodiment, the processor 110 may calculate a pre-lighting time of the test light source 102 according to the sensing data SD, and the sensing data SD is a plurality of sensing values generated from the sensor 120 by measuring the test light source 102 at different time points. For example, when the test light source 102 is activated at a time point t0 to start emitting the light L1, the sensor 120 may synchronously start sensing the test light source 102, and the processor 110 may determine that a variation of the test light source 102 after a time point Ts does not exceed a predetermined range PR according to the sensing data SD, which represents that light emission of the test light source 102 tends to be stable, so that a time interval between the time point t0 and the time point is is recorded as the pre-lighting time of the test light source 102, and only after the pre-lighting time after the test light source 102 has been lighted, the warning device 140 may send a signal to notify the light sensor 106 of the spectrometer 100 to start performing the spectrum measurement to the test object 200, or the processor 110 is electrically connected to the light sensor 106 of the spectrometer 100, and makes the light sensor 106 of the spectrometer 100 to automatically start performing the spectrum measurement to the test object 200 after the pre-lighting time. In another embodiment, the processor 110 may determine the pre-lighting time of the test light source 102 according to whether the sensing data SD exceeds a predetermined threshold.

In another embodiment, referring to FIG. 3, at a time point t1, when the spectrometer 100 starts performing the spectrum measurement to the test object 200, the sensor 120 simultaneously detects the test light source 102 to generate the sensing data SD. During the time interval when the spectrometer 100 performs measurement (i.e. from the time point t1 to the time point t2), the processor 110 may determine whether the detected sensing data SD exceeds the predetermined range PR, and when the sensing data SD exceeds the predetermined range PR, the processor 110 drives the warning device 140 to send a spectrum measurement abnormal signal to notify the user that the spectrum measurement result obtained according to the sensing signal S is probably abnormal. Therefore, the user may consider to again operate the measurement, so as to obtain a reliable spectrum measurement result. Moreover, it should be noted that in the embodiment of FIG. 3, the pre-lighting time and whether the spectrum measurement result is abnormal are determined according to the same predetermined range, though the invention is not limited thereto, and in other embodiments, the predetermined range or a lighting threshold used for determining the pre-lighting time may be different to the predetermined range or a threshold used for determining whether the spectrum measurement result is abnormal.

In an embodiment, the processor 110 may further record a usage time of the test light source 102 to the memory 130. For example, the processor 110 may record a delivery time of the test light source 102 or the usage time of the test light source 102 provided by the user to the memory 130, and the processor 110 may also accumulate time in the memory 130 to record the usage time of the test light source 102 after the test light source 102 is lighted or while the test light source 102 is sensed. The processor 110 may determine whether the test light source is in an aging state according to a comparison result between the sensing data SD generated by the sensor 120 and the predetermined range and the usage time of the test light source 102, so as to remind the user to replace the test light source 102.

FIG. 4 is a schematic diagram of the sensing data varied along with time according to another embodiment of the invention. Referring to FIG. 1 and FIG. 4, if the predetermined range is between a value PR1 and a value PR2, during a first period T1 (a time interval), the sensing data SD produced from the sensor 120 by sensing the test light source 120 falls within the predetermined range, however, after the test light source 102 is used for a period of time, for example, an accumulated usage time of the test light source 102 exceeds a half of an expected service life, during a second period T2, the sensing data SD related to the test light source 120 is lower than a lower limit PR2 of the predetermined range, so that according to the comparison result of the sensing data SD and the predetermined range and the usage time of the test light source 102, the processor 110 determines that the test light source 102 is in the aging state, and controls the warning device 140 to send a light source replacing warning signal to remind the user to replace the test light source 102 in the aging state. Moreover, since a brightness of the aged test light source 102 is probably decreased gradually, the processor 110 may correct the predetermined range according to the sensing data SD in the second period T2, for example, to update the predetermined range from the range between the value PR1 and the value PR2 to a range between a value PR3 and a value PR4, and store the same to the memory 130, so as to provide a corrected predetermined range adapted to the test light source 102 in attenuation, and the processor 110 may compare the present sensing data SD with the corrected predetermined range (with an upper limit of the value PR3 and a lower limit of the value PR4) to continually determine the stability of the current test light source 102. The method of correcting the predetermined range is not limited by the invention. For example, the processor 110 may determine the corrected predetermined range according to an average of the sensing data SD within the second period T2 or according to a variation trend of the sensing data SD.

In an embodiment, the accumulated usage time of the test light source 102 is, for example, still short, so that although the sensing data SD exceeds the predetermined range, the processor 110 may determine that the test light source 102 is not in the aging state, and the processor 110 may control the warning device 140 to send the warning signal to remind the user that the state of the test light source 102 is probably abnormal, i.e. the stability of the test light source 102 is poor or brightness thereof is inadequate.

In summary, the embodiments of the invention have one or following advantages or effect. In the aforementioned embodiments of the invention, the sensor is adapted to obtain the sensing data related to the test light source, and the sensing data and the predetermined range are compared to determine the state of the test light source, and when the sensing data falls within the predetermined range, the spectrometer is adapted to perform the spectrum measurement to the test object, and when the sensing data is out of the predetermined range, the warning device sends the warning signal to indicate that the state of the test light source is abnormal. Therefore, the test object measurement result of the spectrometer is reliable, and is obtained in the stable state of the test light source. If the test light source is varied drastically or unstable, the warning device may send the warning signal, and the processor makes the driving device to maintain the driving parameter originally input to the memory, i.e. not change the driving parameter used for controlling the test light source. Moreover, by determining whether the test light source is in the aging state according to the comparison result and the usage time of the test light source, the user may be reminded to replace the aged test light source, and it is adapted to correct the predetermined range for the test light source in attenuation. Therefore, the light source measurement monitoring method and the system thereof of the invention may improve the reliability of the measurement result of the spectrometer to obtain a consistent measurement result, so as to avoid extra maintenance cost caused by individual difference of the light source elements.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents. Moreover, any embodiment of or the claims of the invention is unnecessary to implement all advantages or features disclosed by the invention. Moreover, the abstract and the name of the invention are only used to assist patent searching. Moreover, “first”, “second”, etc. mentioned in the specification and the claims are merely used to name the elements and should not be regarded as limiting the upper or lower bound of the number of the components/devices.

What is claimed is:

1. A light source measurement monitoring method of a spectrometer, comprising:
driving a test light source by a driving parameter;
obtaining sensing data related to the test light source through a sensor;
comparing the sensing data with a predetermined range to generate a comparison result;
starting performing a spectrum measurement to a test object when the sensing data falls within the predetermined range; and
sending a warning signal when the sensing data is out of the predetermined range.

2. The light source measurement monitoring method of the spectrometer as claimed in claim 1, further comprising:
recording a usage time of the test light source, and determining whether the test light source is in an aging state according to the comparison result and the usage time.

3. The light source measurement monitoring method of the spectrometer as claimed in claim 2, wherein when the sensing data is out of the predetermined range, the step of sending the warning signal comprises:
when it is determined that the test light source is not in the aging state, sending an abnormal warning signal; and
when it is determined that the test light source is in the aging state, sending a light source replacing warning signal or correcting the predetermined range according to the sensing data, and comparing the sensing data with the corrected predetermined range.

4. The light source measurement monitoring method of the spectrometer as claimed in claim 1, wherein the sensing data is a plurality of sensing values generated from the sensor by measuring the test light source at different time points.

5. The light source measurement monitoring method of the spectrometer as claimed in claim 1, wherein when the sensing data falls within the predetermined range, the step of starting performing the spectrum measurement to the test object comprises:
simultaneously measuring the test light source by the sensor to generate the sensing data; and
when the sensing data is out of the predetermined range, sending a spectrum measurement result abnormal signal.

6. The light source measurement monitoring method of the spectrometer as claimed in claim 1, wherein the step of obtaining the sensing data related to the test light source through the sensor comprises:
calculating a pre-lighting time of the test light source according to the sensing data, wherein only after the pre-lighting time after the test light source has been lighted, the spectrum measurement is performed to the test object.

7. The light source measurement monitoring method of the spectrometer as claimed in claim 1, wherein the sensor is a light sensor or a temperature sensor, and the sensing data is brightness or a temperature.

8. The light source measurement monitoring method of the spectrometer as claimed in claim 1, wherein the step of sending the warning signal when the sensing data is out of the predetermined range comprises:
maintaining the driving parameter.

9. A light source measurement monitoring system of a spectrometer, adapted to monitor a spectrometer used for measuring a test object, and comprising:
a sensor, disposed beside a test light source, and configured to sense the test light source driven by a driving parameter and obtain sensing data related to the test light source;
a memory, storing the driving parameter and a predetermined range;
a warning device, sending a warning signal; and
a processor, coupled to the memory, the warning device and the sensor, and receiving the sensing data from the sensor and comparing the sensing data with the predetermined range to generate a comparison result,
wherein when the sensing data falls within the predetermined range, the spectrometer starts performing a spectrum measurement to the test object, and when the sensing data is out of the predetermined range, the processor controls the warning device to send the warning signal.

10. The light source measurement monitoring system of the spectrometer as claimed in claim 9, wherein the processor records a usage time of the test light source to the memory, and determines whether the test light source is in an aging state according to the comparison result and the usage time.

11. The light source measurement monitoring system of the spectrometer as claimed in claim 10, wherein when the processor determines that the test light source is not in the aging state, the processor controls the warning device to send an abnormal warning signal, and when the processor determines that the test light source is in the aging state, the processor controls the warning device to send a light source replacing warning signal or corrects the predetermined range according to the sensing data, and compares the sensing data with the corrected predetermined range.

12. The light source measurement monitoring system of the spectrometer as claimed in claim 9, wherein the sensing data is a plurality of sensing values generated from the sensor by measuring the test light source at different time points.

13. The light source measurement monitoring system of the spectrometer as claimed in claim 9, wherein when the spectrometer starting performing the spectrum measurement to the test object, the sensor simultaneously measures the test light source to generate the sensing data, and when the sensing data is out of the predetermined range, the warning device sends a spectrum measurement result abnormal signal.

14. The light source measurement monitoring system of the spectrometer as claimed in claim 9, wherein the processor calculates a pre-lighting time of the test light source according to the sensing data, and only after the pre-lighting time after the test light source has been lighted, the spectrometer starts performing the spectrum measurement to the test object.

15. The light source measurement monitoring system of the spectrometer as claimed in claim 9, wherein the sensor is a light sensor or a temperature sensor, and the sensing data is brightness or a temperature.

16. The light source measurement monitoring system of the spectrometer as claimed in claim 9, wherein the processor is coupled to a driving device, and the driving device is coupled to the test light source and drives the test light source according to the driving parameter, wherein when the sensing data is out of the predetermined range, the processor controls the driving device to maintain the driving parameter.
